(19) United States
(12) Patent Application Publication
(10) Pub. No.: US 2015/0203392 A1
(43) Pub. Date: Jul. 23, 2015

(54) DRAINAGE TREATMENT SYSTEM AND COMBINED POWER GENERATION FACILITY

(71) Applicant: MITSUBISHI HEAVY INDUSTRIES, LTD., Tokyo (JP)

(72) Inventors: Yoshio Seiki, Tokyo (JP); Shuji Fujii, Tokyo (JP); Masaru Chiyomaru, Tokyo (JP); Atsuhiro Yukumoto, Tokyo (JP)

(73) Assignee: MITSUBISHI HEAVY INDUSTRIES, LTD., Tokyo (JP)

(21) Appl. No.: 14/409,636

(22) PCT Filed: Jun. 28, 2013
(86) PCT No.: PCT/JP2013/067881

§ 371 Date: Dec. 19, 2014

(30) Foreign Application Priority Data
Jul. 3, 2012 (JP) 2012-149466

(51) Int. Cl. C02F 9/00; F01K 23/14; F01K 11/00

(52) U.S. Cl. CPC C02F 9/00; F01K 11/00; F01K 23/14; C02F 1/5245

(57) ABSTRACT

A drainage treatment system 16 of the invention is a drainage treatment system that treats drainage generated when a gasified gas 33 is produced by a coal gasification furnace 12 and is purified by a gas purification device 14, and includes drainage treatment lines L11 to L15 which respectively treat slag drainage, venturi drainage, and stripper drainage generated when the gasified gas 33 is produced and the gasified gas 33 is cleaned and drainage treatment apparatuses 101A to 101E which treat treatment target materials in the drainages discharged from the drainage treatment lines L11 to L15. Accordingly, the drainages of the drainage treatment lines L11 to L15 are respectively and individually treated in response to the treatment target materials contained in the drainages without mixing the drainages of the drainage treatment lines L11 to L15.

### FIELD

The present invention relates to a drainage treatment system which is applied to a treatment for drainage generated when a flue gas such as a coal gasified gas is purified and also relates to a combined power generation facility.

### BACKGROUND

In recent years, the effective utilization of coal has gained attention. For this reason, it is expected that a clean utilization process for coal will be more frequently used in the future. In order to convert the coal into a highly valuable energy medium, an advanced technique such as a coal gasification technique or a gas purification technique is used.

As one of the corresponding techniques of such a system, there is proposed a power generation plant which uses a pure gas obtained by purifying a coal gasified gas (a gasified gas), produced by the gasification of coal, as a turbine gas or a chemical product synthesis plant which uses chemical products such as methanol and ammonia as a raw material for the synthesis. As the facility of the power generation plant that uses the gasified gas to generate power, for example, an IGCC (Integrated Coal Gasification Combined Cycle) system is proposed (for example, see Patent Literatures 1 and 2). The IGCC system indicates a system that converts coal into a combustible gas in a high-temperature and high-pressure gasification furnace so as to generate a gasified gas and performs a complex power generation by using a gas turbine and a steam turbine on the condition that the gasified gas is a fuel.

In the case where the pure gas is generated by purifying the coal gasified gas, a drainage treatment is needed. However, in the general facility of the power generation plant, drainage which is generated in the process of producing the pure gas by purifying the coal gasified gas is recovered and treated at one time and is released under the condition in which the drainage standard is satisfied (for example, see Patent Literatures 3 and 4).

### CITATION LIST

### Patent Literature

Patent Literature 1: Japanese Patent Application Laid-open No. 2004-331701

Patent Literature 2: Japanese Patent Application Laid-open No. 2011-157486

Patent Literature 3: Japanese Patent Application Laid-open No. 2005-224771

Patent Literature 4: Japanese Patent Application Laid-open No. 2011-99071

### SUMMARY

### Technical Problem

However, when the amount of the drainage to be discharged increases with an increase in the size of the facility of the power generation plant of the related art, the drainage treatment amount also increases in the drainage treatment system of the related art. As a result, the amount of the energy which is consumed in the facility of the power generation plant also increases.

For that reason, there has been a demand for a drainage treatment system capable of decreasing the amount of drainage to be discharged by highly efficiently treating drainage generated when a coal gasified gas obtained by gasifying coal is purified to obtain a pure gas with an increase in the size of the facility of the power generation plant.

The invention is made in view of the above-described circumstances, and an object thereof is to provide a drainage treatment system capable of decreasing a drainage amount by highly efficiently treating drainage generated when a coal gasified gas is purified to obtain a pure gas and also to provide a combined power generation facility.

### Solution to Problem

According to an aspect of the present invention, a drainage treatment system that treats drainage generated when a gasified gas is produced by gasifying coal as a fuel in a gasification furnace and is purified by a purification device, includes: a plurality of drainage treatment lines that respectively treat a plurality of drainages generated when the gasified gas is produced and the produced gasified gas is cleaned; and a drainage treatment unit that is provided in each drainage treatment line and treats a treatment target material contained in the drainage discharged from each drainage treatment line. Each drainage of the drainage treatment line is individually treated in response to the treatment target material contained in the drainage without mixing the drainages of the drainage treatment lines.

Advantageously, in the drainage treatment system, the drainages generated when the gasified gas is produced and the produced gasified gas is cleaned correspond to any one of drainage including at least one of a group of alkali metal and alkali earth metal, drainage containing a large amount of ammonia, and final treatment drainage.

Advantageously, in the drainage treatment system, the purification device includes a gas cooling tower that cools the gasified gas, a water cleaning tower that removes at least ammonia in the gasified gas, a H₂S/CO₂ recovery unit that removes any one of or both CO₂ and H₂S in the gasified gas, and a stripper that absorbs ammonia contained in the drainage discharged from the gas cooling tower by using at least an absorbent, and the drainages generated when the gasified gas is produced and the generated gasified gas is cleaned correspond to drainage discharged from any one of the gasification furnace, the water cleaning tower, and the stripper.

Advantageously, in the drainage treatment system, the drainage treatment unit includes a first heavy metal/fluorine treatment unit that removes at least SS, Pb, F, and Hg contained in drainage including at least one of the group of alkali metal and alkali earth metal, and the first heavy metal/fluorine treatment unit includes a sulfide treatment unit that removes at least Pb and Mn contained in drainage including at least one of the group of alkali metal and alkali earth metal from the drainage including at least one of the group of alkali metal and alkali earth metal.

Advantageously, in the drainage treatment system, the first heavy metal/fluorine treatment unit includes any one of or both an As treatment unit that removes at least As contained in drainage including at least one of the group of alkali metal and alkali earth metal by using a ferrite method or an iron powder method, and an SS treatment unit that removes SS contained in drainage including at least one of the group of alkali metal and alkali earth metal by using a filtration treatment method or a membrane treatment method.

Advantageously, in the drainage treatment system, the drainage treatment unit includes a second heavy metal/fluorine treatment unit that removes at least SS, Cr, F, and As in the drainage containing a large amount of ammonia, a first COD treatment unit that removes at least benzene and COD in the drainage containing a large amount of ammonia, a refractory metal treatment unit that removes at least Se in the drainage containing a large amount of ammonia, and an N treatment unit that removes at least NH₃ in the drainage containing a large amount of ammonia. The second heavy metal/fluorine treatment unit includes a calcium fluoride treatment unit that removes at least SS, Cr, and F in the drainage containing a large amount of ammonia by using Ca(OH)₂ and an flocculant and an As treatment unit that removes at least As in the drainage containing a large amount of ammonia by using a ferrite method or an iron powder method. The first COD treatment unit includes an activated coal treatment unit that removes benzene in the drainage containing a large amount of ammonia and treated in the second heavy metal/fluorine treatment unit and a CN treatment unit that removes at least BOD, COD, and CN in the drainage containing a large amount of ammonia by using any one of an oxidization agent,

NaOH, and Fe from the drainage containing a large amount of ammonia and subjected to the activated coal treatment. The refractory metal treatment unit treats the drainage containing a large amount of ammonia and treated in the first COD treatment unit by using any one or more of a ferric hydroxide (III) coprecipitation treatment method, an anaerobic microorganism treatment method, an iron reduction method, and a metallic titanium reduction method. The N treatment unit removes NH₃ in the drainage containing ammonia and treated in the refractory metal treatment unit.

Advantageously, in the drainage treatment system, the drainage treatment unit includes a third heavy metal/fluorine treatment unit that removes at least F in the final treatment drainage, a second COD treatment unit that removes at least benzene and CN in the final treatment drainage, and an N treatment unit that removes at least NH₃ in the final treatment drainage. The third heavy metal/fluorine treatment unit includes a calcium fluoride treatment unit that removes at least SS, Cr, and F in the final treatment drainage by using Ca(OH)₂ and a flocculant. The second COD treatment unit includes a second CN treatment unit that removes at least benzene and CN in the final treatment drainage treated in the third heavy metal/fluorine treatment unit. The N treatment unit removes NH₃ in the final treatment drainage treated in the second COD treatment unit.

Advantageously, in the drainage treatment system, the drainage treatment unit treats drainage generated when the gasified gas is purified by the purification device.

Advantageously, in the drainage treatment system, drainage generated when the gasified gas is purified by the purification device is any one of cooling tower drainage discharged from the gas cooling tower and desulfuration drainage discharged from the H₂S/CO₂ recovery unit.

Advantageously, in the drainage treatment system, the drainage treatment unit includes a fourth heavy metal/fluorine treatment unit that removes at least SS and Fe in the cooling tower drainage, and a third COD treatment unit that removes at least benzene and CN in the cooling tower drainage. The fourth heavy metal/fluorine treatment unit includes an SS/Fe treatment unit that removes at least SS and Fe in the cooling tower drainage by using any one of Na(OH), an oxidization agent, sulfur-based flocculant, manganese zeolite, and ion exchange resin. The third COD treatment unit includes a benzene/BOD/COD treatment unit that treats at least benzene, BOD, and COD in the cooling tower drainage treated in the fourth heavy metal/fluorine treatment unit by using an activated coal treatment method or an activated sludge method.

Advantageously, in the drainage treatment system, the drainage treatment unit includes a fifth heavy metal/fluorine treatment unit that removes at least SS, Fe, Ca, and Hg in the desulfuration drainage, a fourth COD treatment unit that removes at least benzene and CN in the desulfuration drainage, and a refractory metal treatment unit that removes at least Se in the desulfuration drainage. The fifth heavy metal/fluorine treatment unit includes a pH treatment unit that removes at least SS, Fe, and Ca in the desulfuration drainage by adding a pH adjusting agent thereto, and a Hg removal unit that removes Hg in the desulfuration drainage from which at least SS, Fe, and Ca are removed. The fourth COD treatment unit includes an absorption treatment unit that removes at least BOD, COD, thiosulfuric acid, and formic acid in the cooling tower drainage treated in the fifth heavy metal/fluorine treatment unit. The refractory metal treatment unit treats the desulfuration drainage treated in the fourth COD treatment unit by using any one or more of a ferric hydroxide (III) coprecipitation treatment method, an anaerobic microorganism treatment method, an iron reduction method, and a metallic titanium reduction method.

According to another aspect of the present invention, a combined power generation facility includes: a gasification furnace that produces a gasified gas by gasifying coal; a purification device that produces a pure gas by purifying the gasified gas; the drainage treatment system according to any one of the above; a gas turbine; a steam turbine that is driven by steam generated by a heat recovery steam generator; and a condenser that condenses the steam from the steam turbine.

### Advantageous Effects of Invention

According to the invention, the drainage generated when the gasified gas is produced and the drainage generated when the produced gasified gas is cleaned may be supplied to the respective drainage treatment lines, and then each drainage of each drainage treatment line may be treated so that the treatment target material contained in each drainage is treated without mixing the drainages of the drainage treatment lines. For this reason, it is possible to decrease the amount of the drainage to be discharged by highly efficiently treating the drainage generated when the coal gasified gas is purified to obtain the pure gas.

### BRIEF DESCRIPTION OF DRAWINGS

FIG. 1 is a schematic configuration diagram of an integrated coal gasification combined cycle system that employs a drainage treatment system according to an embodiment of the invention.

FIG. 2 is a diagram illustrating an example of a configuration of a gas purification device.

FIG. 3 is an explanatory diagram illustrating each drainage treatment flow of each drainage treatment apparatus.

FIG. 4 is a diagram illustrating an example of the components of the drainage treatment apparatus.

FIG. 5 is a diagram illustrating an example of the components of another drainage treatment apparatus.

FIG. 6 is a diagram illustrating an example of the components of another drainage treatment apparatus.

FIG. 7 is a diagram illustrating an example of the components of another drainage treatment apparatus.

FIG. 8 is a diagram illustrating an example of the components of another drainage treatment apparatus.

FIG. 9 is a diagram illustrating a modified example of a drainage treatment flow.

### DESCRIPTION OF EMBODIMENTS

Hereinafter, the invention will be described in detail with reference to the drawings. Furthermore, the invention is not limited to the embodiment below. Further, the components of the embodiment below include a component which may be easily supposed by the person skilled in the art and a component which has substantially the same configuration, that is, a component included within an equivalent scope. Furthermore, the components disclosed in the embodiment below may be appropriately combined with one another.

### Embodiment

<Integrated Coal Gasification Combined Cycle System>

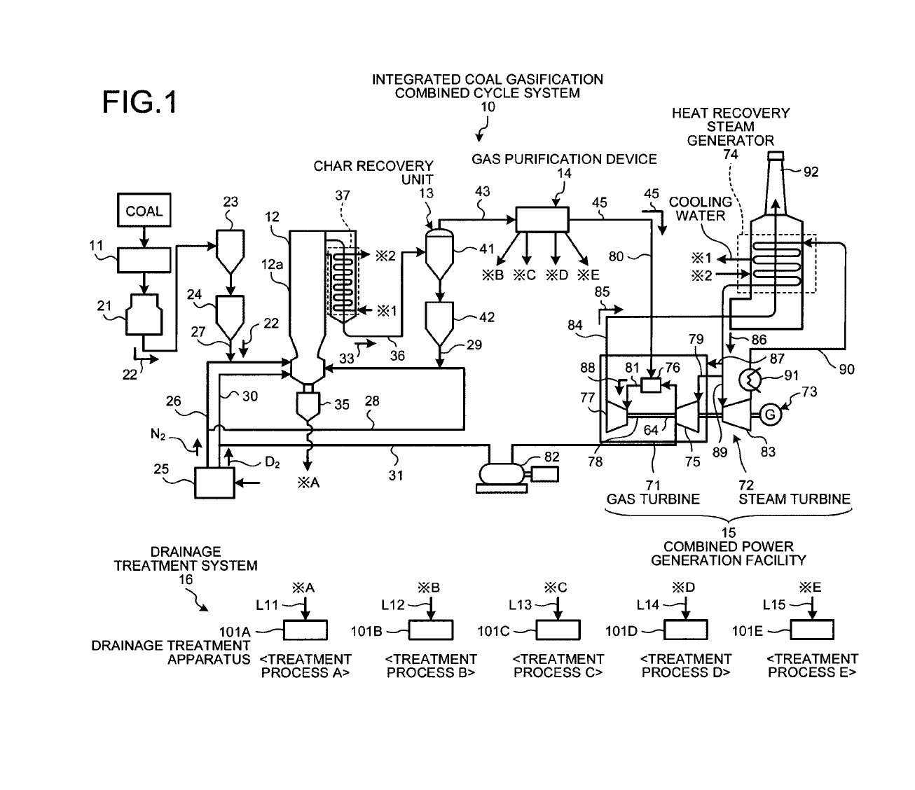

A drainage treatment system according to the embodiment of the invention will be described with reference to the drawings. FIG. 1 is a schematic configuration diagram of an integrated coal gasification combined cycle system that employs the drainage treatment system according to the embodiment of the invention. An IGCC (Integrated Coal Gasification Combined Cycle) system 10 is a combined power generation facility which is configured as an air combustion type that generates a coal gasified gas in a gasification furnace by using air as an oxidization agent and which generates power by supplying a pure gas obtained from a gas purification device as a fuel gas to a gas turbine facility.

As illustrated in FIG. 1, the integrated coal gasification combined cycle system 10 includes a coal feeder 11, a coal gasification furnace 12, a char recovery unit 13, a gas purification device 14, a combined power generation facility 15, and a drainage treatment system 16.

The coal feeder 11 pulverizes raw coal into a predetermined size, heat and dries the pulverized coal by dry steam (superheated steam), removes the moisture contained in the coal, cools the coal, and stores the coal. The raw coal is pulverized into a predetermined size, is heated and dried, and is cooled so as to remove the moisture contained in the raw coal, so that the dry coal is stored in a dry coal bunker. The dry coal which is stored in the coal feeder 11 is input to a coal pulverizer 21.

The coal pulverizer 21 is a coal pulverizing machine, and is used to produce pulverized coal 22 by pulverizing the dry coal into fine particles. The coal pulverizer 21 pulverizes the dry coal stored in the coal feeder 11 into coal (pulverized coal) 22 having a predetermined particle diameter or less. Then, the pulverized coal 22 after pulverized by the coal pulverizer 21 is separated from a carriage gas by a pulverized coal bag filter 23, and is stored in a pulverized coal supply hopper 24. The pulverized coal 22 which is stored in the pulverized coal supply hopper 24 is supplied to a coal gasification furnace 12 through a first nitrogen supply line 26 by the use of nitrogen (N₂) discharged from an air separation device 25.

The air separation device 25 is used to separate N₂ and oxygen (O₂) from the atmospheric air. The first nitrogen supply line 26 is connected to the coal gasification furnace 12, and a coal supply line 27 extending from the pulverized coal supply hopper 24 is connected to the first nitrogen supply line 26. Nitrogen which is discharged from the air separation device 25 that receives the atmospheric air is supplied to the coal gasification furnace 12 through the first nitrogen supply line 26.

Further, a second nitrogen supply line 28 is branched from the first nitrogen supply line 26 and is connected to the coal gasification furnace 12. A char return line 29 extending from the char recovery unit 13 is connected to the second nitrogen supply line 28. Further, an oxygen supply line 30 is connected to the coal gasification furnace 12, and a compressed air supply line 31 that sends compressed air from a gas turbine 71 (a compressor 75) is connected to the oxygen supply line 30, so that the air compressed by the gas turbine 71 can be supplied to the oxygen supply line 30. Thus, nitrogen is used as a gas for carrying the coal or the char, and oxygen is used as an oxidization agent.

The coal gasification furnace 12 produces a coal gasified gas (a gasified gas) 33 by causing the pulverized coal as a fuel to contact a gasification agent such as air or oxygen so that a combustion gas is generated.

The gasified gas 33 which is produced by the coal gasification furnace 12 mainly contains carbon monoxide (CO), hydrogen (H₂), and carbon dioxide (CO₂), and also contains a small amount of an element (for example, heavy metal such as mercury (Hg) and a halogen compound) contained in the coal or an unburnt compound (for example, phenol, an aromatic compound such as anthracene, cyanogen, ammonia, or the like) generated by the coal gasification.

The coal gasification furnace 12 is, for example, an entrained bed type gasification furnace. Here, the pulverized coal and the char supplied into the coal gasification furnace are burned by air (oxygen) so as to gasify the pulverized coal 22 and the char, and hence a combustible gas (a produced gas and a coal gas) mainly containing carbon dioxide is produced. Then, a gasification reaction occurs by using the combustible gas as a gasification agent. Furthermore, the coal gasification furnace 12 is not limited to the entrained bed type gasification furnace, and may be a fluid bed gasification furnace or a fixed bed gasification furnace.

The coal gasification furnace 12 is provided with a slag discharge system 35 which discharges slag generated at a lower portion of a reacting furnace 12a.

The coal gasification furnace 12 is provided with a gasified gas supply line 36 which sends the gasified gas toward the char recovery unit 13. The gasified gas containing the char (unburnt coal) produced by the coal gasification furnace 12 is discharged from the coal gasification furnace 12 through the gasified gas supply line 36.

The gasified gas supply line 36 is provided with a heat exchanger 37. The gasified gas which is discharged from the coal gasification furnace 12 to the gasified gas supply line 36 is cooled to a predetermined temperature by the heat exchanger 37, and is sent to the char recovery unit 13.

The char recovery unit 13 includes a dust recovery unit 41 and a supply hopper 42. The gasified gas 33 containing the char is supplied to the dust recovery unit 41. The gasified gas 33 which is supplied to the dust recovery unit 41 separates the char in the gasified gas 33. The dust recovery unit 41 is a device that removes the char contained in the gasified gas 33 by a cyclone or a filter. Specifically, an EP (Electrostatic Precipitator), a fixed bed filter, a moving bed filter, and the like may be exemplified. The dust recovery unit 41 includes one or plural cyclones or filters. The gasified gas 33 from which the char is separated by the char recovery unit 13 is sent to the gas purification device 14 through the gas discharge line 43.

Meanwhile, the fine char which is separated from the gasified gas is accumulated on the supply hopper 42. The supply hopper 42 is used to store the char separated from the combustible gas by the dust recovery unit 41. Furthermore, a bin is disposed between the dust recovery unit 41 and the supply hopper 42, and a plurality of the supply hoppers 42 may be connected to the bin. The supply hopper 42 is provided with the char return line 29, and the char return line 29 is connected to the second nitrogen supply line 28. The char inside the supply hopper 42 is supplied to the coal gasification furnace 12 through the second nitrogen line 28 by the nitrogen supplied from the air separation device 25 through the char return line 29 so that the char is recycled in the coal gasification furnace 12.

The gas purification device 14 performs a purification process of removing impurities such as a sulfuric compound or a nitrogen compound in the gasified gas 33 generated by the coal gasification furnace 12. The impurities such as a sulfuric compound or a nitrogen compound of the gasified gas 33, from which the char is separated by the char recovery unit 13, are removed by the gas purification device 14, and hence a fuel gas (a pure gas) 45 is produced by the purification of the gas.

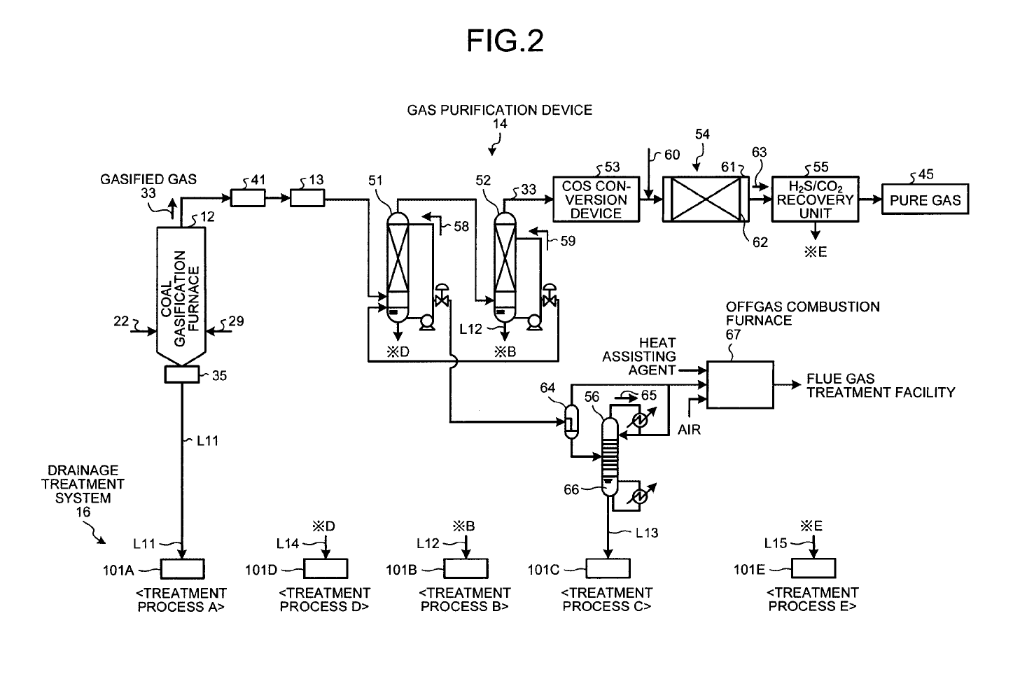

FIG. 2 is a diagram illustrating an example of the configuration of the gas purification device. As illustrated in FIG. 2, the gas purification device 14 includes a gas cooling tower 51, a water cleaning tower 52, a COS conversion device 53, a CO shift reaction device 54, an H₂S/CO₂ recovery unit 55, and a stripper 56.

The gasified gas 33 is sent to the gas cooling tower 51, is cooled by cooling water 58 circulating in the tower, and is supplied to the water cleaning tower 52.

The water cleaning tower 52 is used to remove a chemical material such as ammonia (NH₃), a halogen compound, and hydrogen cyanide in the gasified gas 33. As the watercleaning tower 52, a wet scrubber device which uses a cleaning liquid 59 such as water or an alkaline solution, an absorber which is filled with sodium fluoride (NaF) as a chemical agent for absorbing hydrogen fluoride, and the like may be exemplified. As for the gasified gas 33 which is supplied to the water cleaning tower 52, fine char is cleaned and removed by the cleaning liquid 59 such as water or an alkaline solution and chemical materials such as ammonia, a halogen compound, and hydrogen cyanide are absorbed in the water cleaning tower 52. The gasified gas 33 from which NH₃, a halogen compound, hydrogen cyanide, and the like in the gasified gas 33 are removed by the water cleaning tower 52 is discharged from the water cleaning tower 52 and is supplied to the COS conversion device 53.

The COS conversion device 53 converts carbonyl sulfide (COS) in the gasified gas 33 into H₂S. After COS in the gasified gas 33 is converted into H₂S by the COS conversion device 53, the gasified gas 33 containing H₂S is supplied into the CO shift reaction device 54 along with steam 60 necessary for the CO shift reaction.

The CO shift reaction device 54 reforms carbon monoxide (CO) in the gasified gas 33 so as to be converted into carbon dioxide (CO₂) under a CO shift catalyst. The CO shift reaction device 54 includes an adiabatic reactor (a reactor) 61. The reactor 61 includes therein a CO shift catalyst layer 62 which reforms CO in the gasified gas 33 so that CO is converted into CO₂ and is filled with a CO shift catalyst performing a so-called CO shift reaction. As the CO shift catalyst that promotes the CO shift reaction, an existing example may be used, and hence the alternative example is not particularly limited.

Furthermore, the CO shift reaction device 54 includes one adiabatic reactor, but may include a plurality of adiabatic reactors. The CO shift reaction device 54 causes a CO shift reaction that converts CO in the gasified gas 33 into CO₂ so that CO in the gasified gas 33 is converted into CO₂. A reformed gas 63 which is obtained by the CO shift reaction device 54 is supplied to the H₂S/CO₂ recovery unit 55.

The H₂S/CO₂ recovery unit 55 is a device that removes carbon dioxide (CO₂) and hydrogen sulfide (H₂S) in the gasified gas 33. The H₂S/CO₂ recovery unit 55 removes CO₂ and H₂S in the reformed gas 63. As the H₂S/CO₂ recovery unit 55, the recovery unit including an absorber and a regenerator may be exemplified. The absorber recovers CO₂ and H₂S in the gasified gas 33 by absorbing CO₂ and H₂S in the gasified gas 33 to the absorbent. The absorbent that absorbs CO₂ and H₂S is supplied to the regenerator, and the regenerator heats the absorbent by a regenerative heater. Accordingly, CO₂ and H₂S are separated from the absorbent, and hence the absorbent is regenerated. The regenerated absorbent is circulated to the absorber so as to be used therein again. A pure gas 45 which is treated by the H₂S/CO₂ recovery unit 55 is supplied to the combined power generation facility 15. The pure gas 45 is used as the turbine gas of the power generation plant. Further, the amine absorbent that absorbs H₂S in the reformed gas 63 is finally recovered as calcium sulfate, and hence is effectively used.

Furthermore, the H₂S/CO₂ recovery unit 55 is used to remove both CO₂ and H₂S. However, a configuration may be employed in which a device removing CO₂ and a device removing H₂S are provided in parallel and individually remove CO₂ and H₂S.

Further, the installation positions of the gas cooling tower 51, the water cleaning tower 52, the COS conversion device 53, the CO shift reaction device 54, and the H₂S/CO₂ recovery unit 55 are not limited thereto, and may be appropriately changed.

Further, a part of the cleaning liquid 59 of the water cleaning tower 52 is circulated to the gas cooling tower 51, and is mixed with the cleaning liquid 59 so as to be used as the cooling water 58. A part of the cooling water 58 which is circulated and used in the gas cooling tower 51 is extracted and sent to a flash drum 64. Since the cleaning liquid 59 contains ammonia (NH₃) that is absorbed from the gasified gas 33 in the water cleaning tower 52 as described above, NH₃ is contained in the cooling water 58 when the cleaning liquid 59 absorbing ammonia is mixed with the cooling water 58.

The cooling water 58 is sent to the stripper 56 through the flash drum 64. The stripper 56 performs a stripping treatment on NH₃ from the cooling water 58 absorbing ammonia so that an offgas 65 containing NH₃ and a remaining washing liquid 66 are separated. The stripper 56 is generally operated at 80° C. at the upper stage and is operated at 130° C. at the lower stage. Further, in the stripper 56, H₂S contained in the cooling water 58 is also removed, and hence is contained in the offgas 65 along with NH₃. Thus, the washing liquid 66 subjected to the stripping treatment does not contain NH₃ and H₂S. The offgas 65 containing NH₃ and H₂S is sent to an offgas combustion furnace 67 along with combustion improver and air so as to be burned together.

Next, as illustrated in FIG. 1, the pure gas 45 which is treated by the H₂S/CO₂ recovery unit 55 is supplied to the combined power generation facility 15. The combined power generation facility 15 includes a gas turbine 71, a steam turbine 72, a generator 73, and an HRSG (Heat Recovery Steam Generator) 74.

The gas turbine 71 includes a compressor 75, a combustor 76, and a turbine 77, and the compressor 75 and the turbine 77 are connected to each other by a rotation shaft 78. A compressed air supply line 79 extending from the compressor 75 and a fuel gas supply line 80 extending from the gas purification device 14 are connected to the combustor 76, and a combustion gas supply line 81 is connected to the turbine 77. Further, the gas turbine 71 is provided with the compressed air supply line 31 that extends from the compressor 75 to the coal gasification furnace 12, and a booster 82 is provided in the middle thereof. The compressed air which is extracted from the gas turbine 71 is boosted by the booster 82, and is supplied to the coal gasification furnace 12 through the compressed air supply line 31 along with oxygen supplied from the air separation device 25.

The steam turbine 72 includes a turbine 83 that is connected to the rotation shaft 78 of the gas turbine 71, and the generator 73 is connected to the base end of the rotation shaft 78.

The heat recovery steam generator 74 is provided in a flue gas line 84 that extends from the turbine 77 of the gas turbine 71, and steam 86 is generated by the heat exchange between air and a high-temperature flue gas 85 discharged from the turbine 77.

The combined power generation facility 15 supplies the pure gas 45 to the combustor 76 of the gas turbine 71 as the generation unit. The gas turbine 71 generates compressed air by compressing the air 87 supplied to the compressor 75, and supplies the compressed air to the combustor 76. The gas turbine 71 generates a high-temperature and high-pressure combustion gas 88 by mixing and burning the compressed air supplied from the compressor 75 and the pure gas 45 supplied from the gas purification device 14. When the turbine 77 is driven by the combustion gas 88 so as to rotate the rotation shaft 78, the generator 73 is driven through the rotation shaft 78, and hence power may be generated.

Then, the flue gas 85 which is discharged from the turbine 77 of the gas turbine 71 exchanges heat with air in the heat recovery steam generator 74 so as to generate the steam 86, and the generated steam 86 is supplied to the steam turbine 72. A steam supply line 89 is provided between the heat recovery steam generator 74 and the turbine 83 of the steam turbine 72, and the heat recovery steam generator is provided with a steam recovery line 90 which recovers the steam 86 used in the turbine 83. Further, the steam recovery line 90 is provided with a condenser 91. Thus, in the steam turbine 72, the turbine 83 is driven by the steam 86 supplied from the heat recovery steam generator 74 so as to rotate the rotation shaft 78, and the generator 73 is driven by the rotation, thereby generating power. Then, the steam 86 having been used in the steam turbine 72 is discharged from the steam turbine 72, is cooled by the condenser 91, and is supplied to the heat recovery steam generator 74.

Then, the flue gas 85 of which the heat is recovered by the heat recovery steam generator 74 passes through a gas purification device such as a denitration device (not illustrated) so that a toxic material is removed therefrom, and the purified flue gas 85 is discharged to the atmosphere through a stack 92.

[Drainage Treatment System]

Next, the drainage treatment system 16 according to the embodiment provided in the integrated coal gasification combined cycle system 10 is used to treat drainage which is generated during the process in which the pulverized coal 22 is gasified by the coal gasification furnace 12 so as to generate the gasified gas 33 and the gasified gas is purified by the gas purification device 14. In the embodiment, drainage containing at least one of a group of alkali metal and alkali earth metal, drainage containing a large amount of ammonia, and final treatment drainage are used as drainage generated when the gasified gas 33 is generated and the generated gasified gas 33 is cleaned.

Furthermore, drainage generated when the gasified gas 33 is generated and the generated gasified gas 33 is cleaned is not limited thereto, and any drainage may be used as long as drainage is produced when the gasified gas 33 is generated and the generated gasified gas 33 is cleaned.

In the embodiment, slag drainage 94 which is discharged from the slag discharge system 35 when the coal gasification furnace 12 generates the gasified gas 33 is used as drainage containing at least one of a group of alkali metal and alkali earth metal.

In the embodiment, venturi drainage 95 which is discharged when the gasified gas 33 is cleaned by the water cleaning tower 52 is used as drainage containing a large amount of ammonia.

In the embodiment, stripper drainage 96 which is discharged when ammonia is removed by the stripper 56 is used as final treatment drainage.

Further, the drainage treatment system 16 according to the embodiment may also treat drainage generated when the gasified gas 33 is purified by the gas purification device 14. In the embodiment, cooling tower drainage 97 discharged from the gas cooling tower 51 and desulfuration drainage 98 discharged from the H₂S/CO₂ recovery unit 54 are used as drainage which is generated when the gasified gas 33 is purified by the gas purification device 14.

Furthermore, drainage which is generated when the gasified gas 33 is purified by the gas purification device 14 is not limited thereto, and any drainage may be used as long as drainage is generated when the gasified gas 33 is purified by the gas purification device 14.

The drainage treatment system 16 according to the embodiment includes drainage treatment lines L11 to L15 and drainage treatment apparatuses (drainage treatment units) 101A to 101E. The drainage treatment line L11 is a line which is connected to the coal gasification furnace 12 and treats the slag drainage 94 discharged from the slag discharge system 35. The drainage treatment line L12 is a line which is connected to the water cleaning tower 52 and treats the venturi drainage 95 discharged from the water cleaning tower 52. The drainage treatment line L13 is a line which is connected to the stripper 56 and treats the stripper drainage 96 discharged from the stripper 56. The drainage treatment line L14 is a line which is connected to the gas cooling tower 51 and treats the cooling tower drainage 97 discharged from the gas cooling tower 51. The drainage treatment line L15 is a line which is connected to the H₂S/CO₂ recovery unit 54 and treats the desulfuration drainage 98 discharged from the H₂S/CO₂ recovery unit 54.

The drainage treatment apparatuses 101A to 101E are used to treat the treatment target materials contained in the slag drainage 94, the venturi drainage 95, the stripper drainage 96, the cooling tower drainage 97, and the desulfuration drainage 98 respectively discharged from the drainage treatment lines L11 to L15. The drainage treatment apparatuses 101A to 101E are connected to the drainage treatment lines L11 to L15, and the drainage treatment apparatuses 101A to 101E respectively treat the slag drainage 94, the venturi drainage 95, the stripper drainage 96, the cooling tower drainage 97, and the desulfuration drainage 98.

Furthermore, in the embodiment, drainages (in the embodiment, the cooling tower drainage 97 and the desulfuration drainage 98) which are generated when the gasified gas 33 is purified by the gas purification device 14 are also treated other than drainages (in the embodiment, the slag drainage 94, the venturi drainage 95, and the stripper drainage 96) generated when the gasified gas 33 is purified by the gas purification device 14, but only the drainage generated when the gasified gas 33 is purified by the gas purification device 14 may be treated.

An example will be described in which the drainage treatment apparatuses 101A to 101E respectively treat the slag drainage 94, the venturi drainage 95, the stripper drainage 96, the cooling tower drainage 97, and the desulfuration drainage 98.

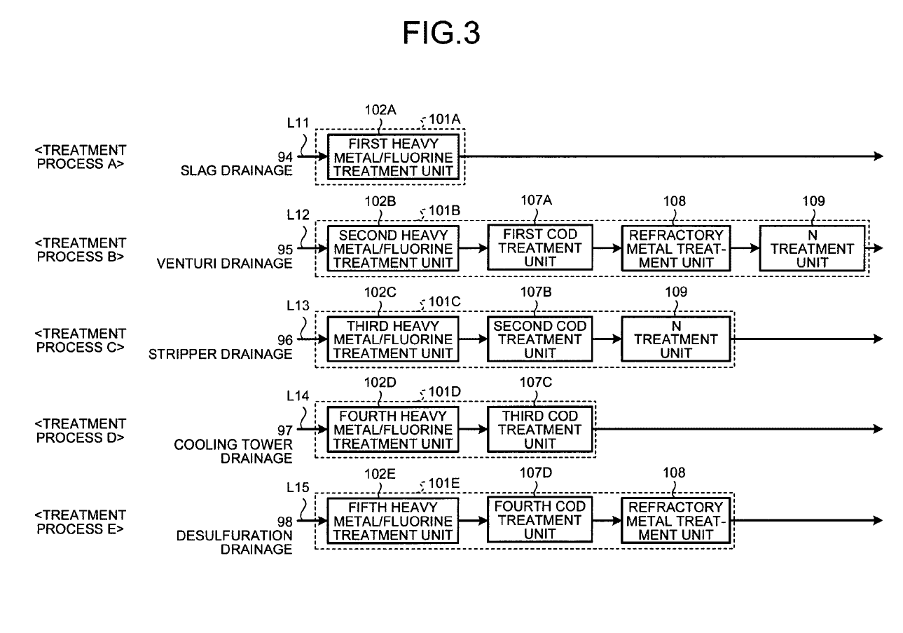

FIG. 3 is an explanatory diagram illustrating each drainage treatment flow of the drainage treatment apparatuses 101A to 101E. As illustrated in FIG. 3, the slag drainage 94, the venturi drainage 95, the stripper drainage 96, the cooling tower drainage 97, and the desulfuration drainage 98 are respectively and individually treated by the drainage treatment apparatuses 101A to 101E.

(Treatment Process A)

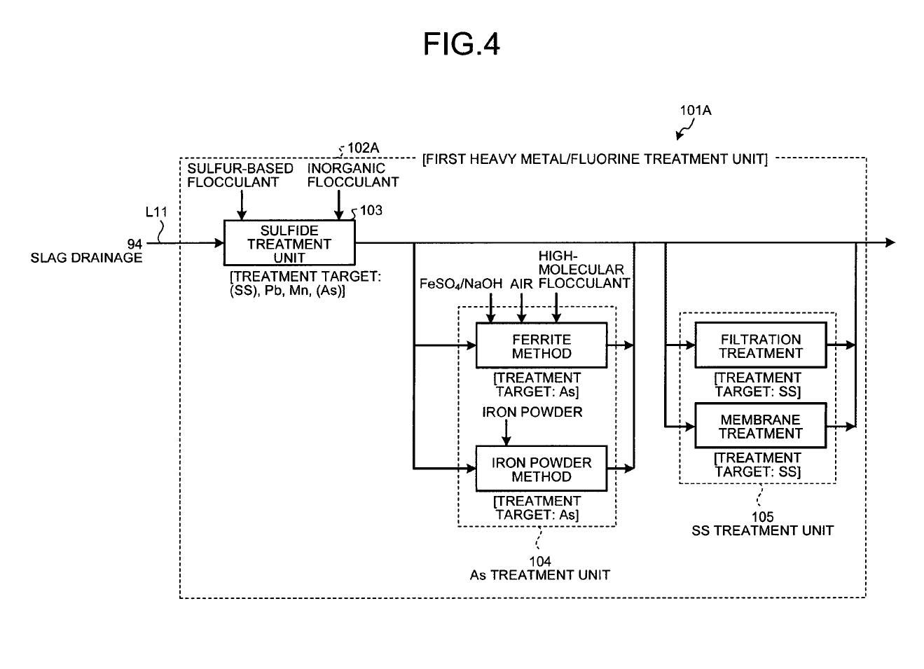

The slag drainage 94 is supplied to the drainage treatment apparatus 101A through the drainage treatment line L11 (Treatment Process A). The drainage treatment apparatus 101A removes fluorine or heavy metal such as SS, Pb, F, and Hg contained in the slag drainage 94. An example of the components of the drainage treatment apparatus 101A is illustrated in FIG. 4. As illustrated in

FIG. 4, the drainage treatment apparatus 101A includes a first heavy metal/fluorine treatment unit 102A which removes at least SS, Pb, F, and Hg contained in the slag drainage 94. The first heavy metal/fluorine treatment unit 102A includes a sulfide treatment unit 103, an As treatment unit 104, and an SS treatment unit 105.

The sulfide treatment unit 103 removes at least Pb and Mn contained in the slag drainage 94 by treating the slag drainage 94 using a sulfide method. In the embodiment, SS and As may be also removed.

The sulfide method is a method of aggregating and settling Pb, Mn, and the like contained in the slag drainage 94 by using sulfur-based flocculant and inorganic flocculant. As the sulfur-based flocculant, for example, pyridine, imine, and carbamic sulfur-based flocculants may be exemplified. As the inorganic flocculant, for example, polyaluminum chloride, ferric chloride, and the like may be exemplified. By using the sulfide method, Pb and Mn contained in the slag drainage 94 are removed.

When As is contained in the slag drainage 94 which is treated by the sulfide treatment unit 103 according to the sulfide method, the slag drainage is supplied to the As treatment unit 104.

The As treatment unit 104 removes at least As contained in the slag drainage 94 by using a ferrite method or an iron powder method.

In the ferrite method, ferrite is produced by adding alkaline (for example, NaOH) to a solution (FeSO₄) containing bivalent ferrous ion (Fe²⁺) and adding air thereto for an oxidization treatment. Subsequently, high-molecular flocculant is added thereto so as to aggregate and settle the produced ferrite. Accordingly, As contained in the slag drainage 94 is removed.

In the iron powder method, As is reduced and deposited due to a difference in ionization tendency so as to be coprecipitated with Fe. Accordingly, As contained in the slag drainage 94 is removed.

When SS is contained in the slag drainage 94 treated by the sulfide treatment unit 103 according to the sulfide method or the slag drainage 94 treated by the As treatment unit 104, the slag drainage is supplied to the SS treatment unit 105.

The SS treatment unit 105 removes at least SS contained in the slag drainage 94 by the filtration treatment method or the membrane treatment method.

As the filtration treatment method, for example, a sand filer tower, a gravity filter tower, a pressure filter tower, an upward flow filter, a moving filter, and the like are used. Further, as the membrane treatment method, for example, a cartridge filter, an MF membrane, a ceramic membrane, an UF membrane, and the like are used.

The slag drainage 94 which is treated by the first heavy metal/fluorine treatment unit 102A in the drainage treatment apparatus 101A is discharged from the drainage treatment apparatus 101A. Further, the treated slag drainage 94 may be recycled as boiler water in the heat recovery steam generator 74 so as to be used therein again.

Thus, it is possible to highly efficiently remove the heavy metal such as SS, Pb, Mn, and As contained in the slag drainage 94 in accordance with the properties thereof by supplying the slag drainage 94 to the drainage treatment apparatus 101A through the drainage treatment line L11 and to recycle the treated slag drainage 94 as boiler water in the heat recovery steam generator 74 so as to be used therein again. For this reason, it is possible to decrease the amount of the drainage discharged from the integrated coal gasification combined cycle system 10.

(Treatment Process B)

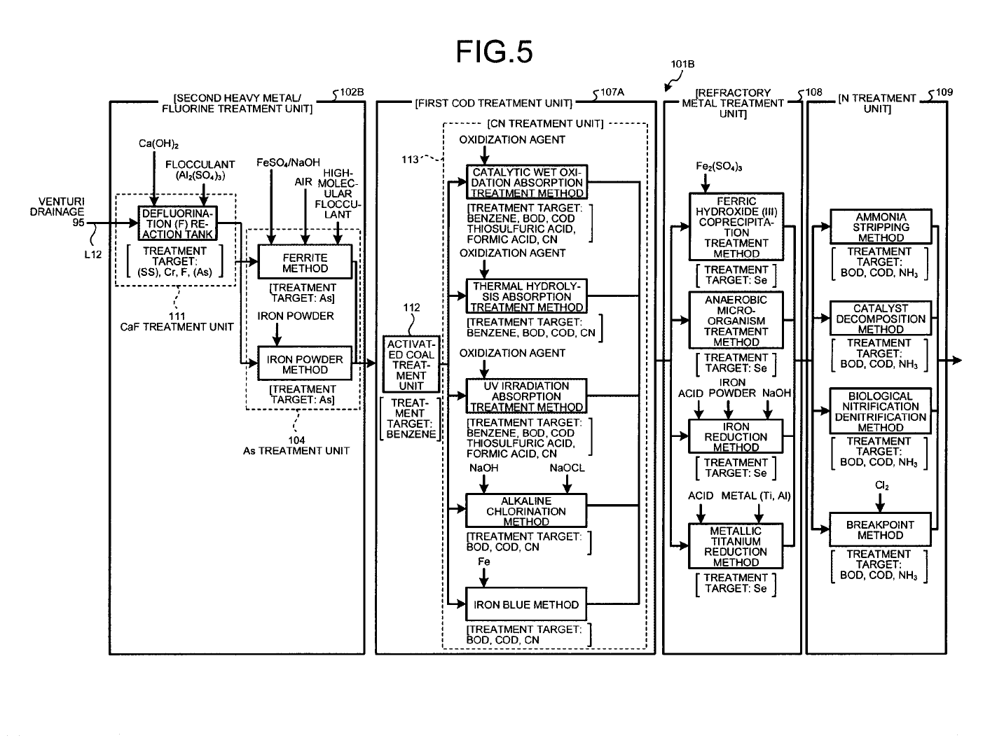

The venturi drainage 95 is supplied to the drainage treatment apparatus 101B through the drainage treatment line L12 (in FIGS. 1 and 2, the treatment process B). The drainage treatment apparatus 101B removes fluorine or heavy metal such as SS, Pb, F, Hg, benzene, CN, and Se contained in the venturi drainage 95. An example of the components of the drainage treatment apparatus 101B is illustrated in FIG. 5. As illustrated in FIG. 5, the drainage treatment apparatus 101E includes a second heavy metal/fluorine treatment unit 102B, a first COD treatment unit 107A, a refractory metal treatment unit 108, and an N treatment unit 109.

(Second Heavy Metal/Fluorine Treatment Unit)

The second heavy metal/fluorine treatment unit 102B is used to remove at least SS, Cr, F, and As. The second heavy metal/fluorine treatment unit 102B includes a CaF (calcium fluoride) treatment unit 111 and the As treatment unit 104. The CaF treatment unit 111 removes at least SS, Cr, and F contained in the venturi drainage 95 by using Ca(OH)₂ and flocculant. The As treatment unit 104 removes at least As contained in the venturi drainage 95 by using a ferrite method or an iron powder method.

The CaF treatment unit 111 aggregates and settles SS, Cr, F, As, and the like contained in the venturi drainage 95 by adding calcium hydroxide (Ca(OH)₂) and an flocculant into a defluorination (F) reaction tank. As the flocculant, for example, aluminum sulfate (Al₂(SO₄)₃) and the like are used.

F in the venturi drainage 95 causes a reaction with Ca(OH)₂ as the following equation so as to generate calcium fluoride (CaF₂), and is settled and removed.

2HF+Ca(OH)₂→CaF₂+2H₂O

Since the generated CaF₂ is not easily settled due to the colloidal state, the generated CaF₂ is coprecipitated with Al(OH)₃ produced by the addition of Al₂(SO₄)₃ and hence is removed from the venturi drainage 95.

After at least SS, Cr, and F contained in the venturi drainage 95 are removed by the CaF treatment unit 111, the venturi drainage 95 is supplied to the As treatment unit 104.

The As treatment unit 104 removes at least As contained in the venturi drainage 95 using a ferrite method or an iron powder method with respect to the venturi drainage 95 treated in the CaF treatment unit 111. Since the ferrite method or the iron powder method is the same as that of the As treatment unit 104 of the drainage treatment apparatus 101A, the description will not be repeated herein.

After at least As contained in the venturi drainage 95 is removed by the As treatment unit 104, the venturi drainage 95 is supplied to the first COD treatment unit 107A.

(First COD Treatment Unit)

The first COD treatment unit 107A removes at least benzene and COD contained in the venturi drainage 95. The first COD treatment unit 107A includes an activated coal treatment unit 112 and a CN treatment unit 113. The activated coal treatment unit 112 removes benzene in the venturi drainage 95 which is treated by the second heavy metal/fluorine treatment unit 102B. The CN treatment unit 113 removes BOD, COD, and CN in the venturi drainage 95 by using any one of an oxidization agent, NaOH, and Fe with respect to the venturi drainage 95 subjected to the activated coal treatment.

The activated coal treatment unit 112 absorbs and removes benzene contained in the venturi drainage 95 by performing an activated coal treatment on the venturi drainage 95 treated in the second heavy metal/fluorine treatment unit 102B.

After at least benzene contained in the venturi drainage 95 is removed by the activated coal treatment unit 112, the venturi drainage 95 is supplied to the CN treatment unit 113.

The CN treatment unit 113 removes at least BOD, COD, and CN in the venturi drainage 95 by using any one of an oxidization agent, NaOH, and Fe with respect to the venturi drainage 95 subjected to the activated coal treatment. Specifically, a catalytic wet oxidation absorption treatment method, a thermal hydrolysis absorption treatment method, an UV irradiation absorption treatment method, an alkaline chlorination method, an iron blue method, and the like may be used in the CN treatment unit 113.

In the catalytic wet oxidation absorption treatment method, benzene, BOD, COD, thiosulfuric acid, formic acid, and CN in the venturi drainage 95 are removed by adding an oxidization agent into the venturi drainage 95.

In the thermal hydrolysis absorption treatment method, benzene, BOD, COD, and CN in the venturi drainage 95 are removed by adding an oxidization agent to the venturi drainage 95.

In the UV irradiation absorption treatment method, benzene, BOD, COD, thiosulfuric acid, formic acid, and CN in the venturi drainage 95 are removed by adding an oxidization agent to the venturi drainage 95.

In the alkaline chlorination method, BOD, COD, and CN in the venturi drainage 95 are removed by adding NaOH to the venturi drainage 95 and adding NaOCl thereto.

In the iron blue method, BOD, COD, and CN in the venturi drainage 95 are removed by adding Fe to the venturi drainage 95.

After BOD, COD, and CN contained in the venturi drainage 95 are removed by the CN treatment unit 113, the venturi drainage 95 is supplied to the refractory metal treatment unit 108.

(Refractory metal Treatment Unit)

The refractory metal treatment unit 108 removes at least Se contained in the venturi drainage 95. In the refractory metal treatment unit 108, the venturi drainage 95 which is treated in the first COD treatment unit 107A is treated by using at least one of a ferric hydroxide (III) coprecipitation treatment method, an anaerobic microorganism treatment method, an iron reduction method, and a metallic titanium reduction method. Accordingly, at least Se in the venturi drainage 95 is removed.

In the ferric hydroxide (III) coprecipitation treatment method, Se is removed from the venturi drainage 95 by adding Fe₂(SO₄)₃ to the venturi drainage 95 treated in the first COD treatment unit 107A.

In the anaerobic microorganism treatment method, Se is removed from the venturi drainage 95 by performing an anaerobic microorganism treatment on the venturi drainage 95 treated in the first COD treatment unit 107A.

In the iron reduction method, Se is removed from the venturi drainage 95 by aggregating and settling Se in a manner such that acid, iron powder, and NaOH are added to the venturi drainage 95 treated in the first COD treatment unit 107A.

In the metallic titanium reduction method, Se is aggregated and settled by adding acid and metal (for example, Ti and Al) to the venturi drainage 95 treated in the first COD treatment unit 107A.

After at least Se contained in the venturi drainage 95 is removed by the refractory metal treatment unit 108, the venturi drainage 95 is supplied to the N treatment unit 109.

(N Treatment Unit)

The N treatment unit 109 removes at least NH₃ contained in the venturi drainage 95. The N treatment unit 109 removes NH₃ contained in the venturi drainage 95 treated in the refractory metal treatment unit 108.

In the N treatment unit 109, for example, an ammonia stripping method, a decomposition method using a catalyst, a biological nitrification denitrification method, a breakpoint method, and the like are used. Any one of the treatment methods removes at least NH₃, BOD, and COD.

In the ammonia stripping method, for example, at least NH₃, BOD, and COD contained in the venturi drainage 95 are removed by using the stripper 56 or the like.

In the decomposition method using a catalyst, for example, at least NH₃, BOD, and COD contained in the venturi drainage 95 are removed by causing the venturi drainage 95 to flow through the catalyst charging tank filled with a catalyst.

In the biological nitrification denitrification method, for example, at least NH₃, BOD, and COD contained in the venturi drainage 95 are removed by adding acid, iron powder, and NaOH to the venturi drainage 95 in a manner such that the venturi drainage 95 flows through a nitrification tank and a denitrification tank in the combination of the aerobic treatment (nitrification) and the anaerobic treatment (denitrification).

In the breakpoint method, at least NH₃, BOD, and COD contained in the venturi drainage 95 are removed by adding chlorine (Cl₂) or sodium hypochlorite as an oxidization agent to the venturi drainage 95.

After NH₃, BOD, and COD contained in the venturi drainage 95 are removed by the N treatment unit 109, the venturi drainage 95 is discharged from the drainage treatment apparatus 101B.

Thus, since it is possible to highly efficiently remove F or heavy metal such as SS, Cr, As, and Se contained in the venturi drainage 95 in accordance with the properties and the states thereof by supplying the venturi drainage 95 to the drainage treatment apparatus 91B through the drainage treatment line L12, it is possible to decrease the amount of the drainage discharged from the integrated coal gasification combined cycle system 10.

(Treatment Process C)

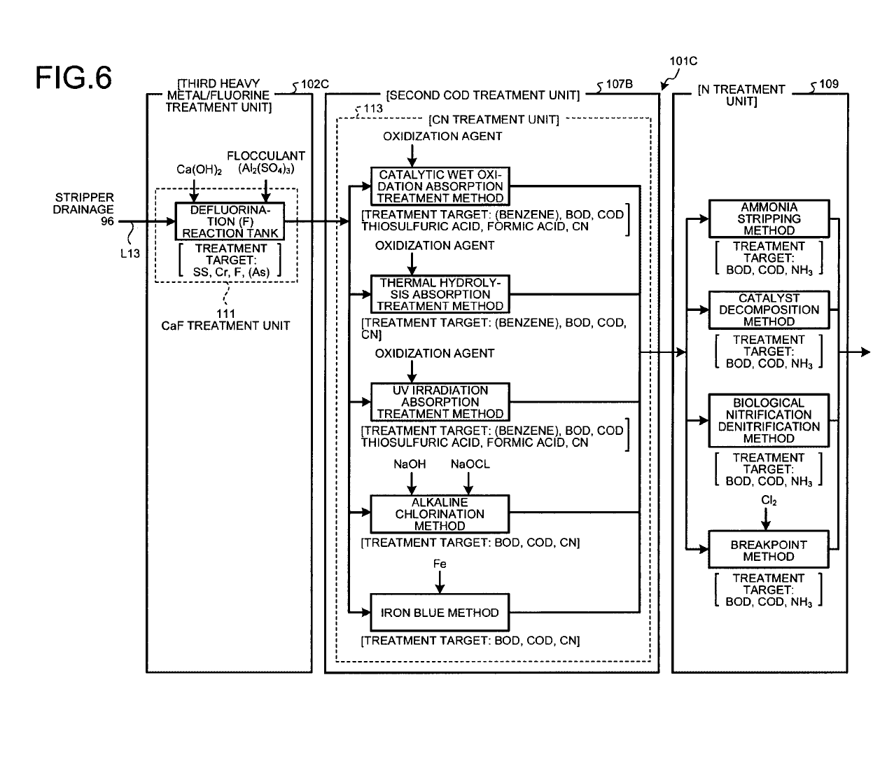

The stripper drainage 96 is supplied to the drainage treatment apparatus 101C through the drainage treatment line L13 (in FIGS. 1 and 2, the treatment process C). The drainage treatment apparatus 101C removes fluorine or heavy metal such as F, BOD, COD, thiosulfuric acid, formic acid, CN, and T—N contained in the stripper drainage 96. An example of the components of the drainage treatment apparatus 101C is illustrated in FIG. 6. As illustrated in FIG. 6, the drainage treatment apparatus 101C includes a third heavy metal/fluorine treatment unit 102C, a second COD treatment unit 107B, and an N treatment unit 109.

(Third Heavy Metal/Fluorine Treatment Unit)

The third heavy metal/fluorine treatment unit 102C is used to remove at least F contained in the stripper drainage 96. The third heavy metal/fluorine treatment unit 102C includes the CaF treatment unit 111. The CaF treatment unit 111 removes at least SS, Cr, and F contained in the stripper drainage 96 by using Ca(OH)₂ and flocculant. Since the CaF treatment unit 111 is the same as the above-described CaF treatment unit 111 of the second heavy metal/fluorine treatment unit 102B, the repetitive description thereof will be omitted.

After at least SS, Cr, and F contained in the stripper drainage 96 are removed by the third heavy metal/fluorine treatment unit 102C, the stripper drainage 96 is supplied to the second COD treatment 107B.

(Second COD Treatment Unit)

The second COD treatment 107B is used to remove at least BOD, COD, and CN contained in the stripper drainage 96. The second COD treatment 107B includes the CN treatment unit 113. The CN treatment unit 113 removes at least CN in the stripper drainage 96 treated in the third heavy metal/fluorine treatment unit 102C. Since the CN treatment unit 113 is the same as the above-described CN treatment unit 113 of the first COD treatment unit 107A, the repetitive description thereof will be omitted.

After at least CN contained in the stripper drainage 96 is removed by the second COD treatment 107B, the stripper drainage 96 is supplied to the N treatment unit 109.

(N Treatment Unit)

The N treatment unit 109 is used to remove at least NH₃ contained in the stripper drainage 96. The N treatment unit 109 removes NH₃ contained in the stripper drainage 96 treated in the second COD treatment 107B. Since the N treatment unit 109 is the same as the above-described N treatment unit 109, the repetitive description thereof will be omitted.

After benzene and CN contained in the stripper drainage 96 are removed by the N treatment unit 109, the stripper drainage 96 is discharged from the drainage treatment apparatus 101C.

Thus, since it is possible to highly efficiently remove fluorine or heavy metal such as BOD, COD, thiosulfuric acid, formic acid, CN, and T—N contained in the stripper drainage 96 in accordance with the properties and the states thereof by supplying the stripper drainage 96 to the drainage treatment apparatus 101C through the drainage treatment line L13, it is possible to decrease the amount of the drainage discharged from the integrated coal gasification combined cycle system 10.

(Treatment Process D)

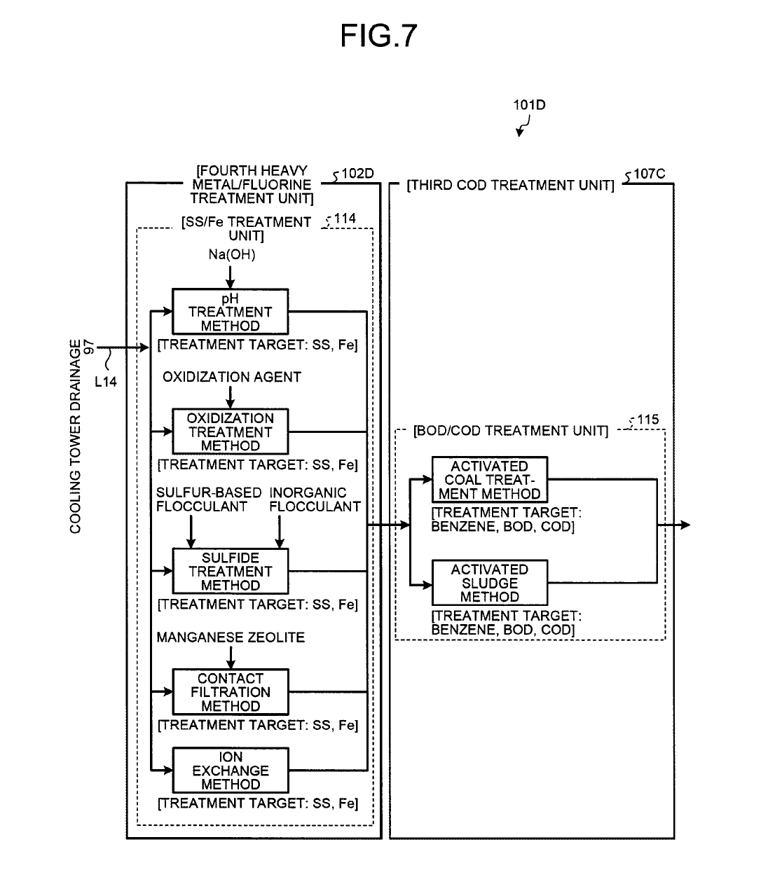

The cooling tower drainage 97 is supplied to the drainage treatment apparatus 101D through the drainage treatment line L14 (in FIGS. 1 and 2, the treatment process D). The drainage treatment apparatus 101D removes fluorine or heavy metal such as SS, Fe, benzene, BOD, and COD contained in the cooling tower drainage 97. An example of the components of the drainage treatment apparatus 101D is illustrated in FIG. 7. As illustrated in FIG. 7, the drainage treatment apparatus 101D includes a fourth heavy metal/fluorine treatment unit 102D and a third COD treatment unit 107C.

(Fourth Heavy Metal/Fluorine Treatment Unit)

The fourth heavy metal/fluorine treatment unit 102D is used to remove at least SS and Fe contained in the cooling tower drainage 97. The fourth heavy metal/fluorine treatment unit 102D includes an SS/Fe treatment unit 114.

The SS/Fe treatment unit 114 removes at least SS and Fe contained in the cooling tower drainage 97 by using any one of a pH treatment method of adding Na(OH) to the cooling tower drainage 97, an oxidization treatment method of adding an oxidization agent to the cooling tower drainage 97, a sulfide treatment method of adding sulfur-based flocculant to the cooling tower drainage 97, a contact filtration method of causing the cooling tower drainage 97 to pass through manganese zeolite, and an ion exchange method of causing the cooling tower drainage 97 to pass through an ion exchange resin.

In the pH treatment method, SS and Fe contained in the cooling tower drainage 97 are settled and removed by adding Na(OH) to the cooling tower drainage 97 so that pH of the cooling tower drainage 97 becomes about 9.0 to 10.5.

In the oxidization treatment method, SS and Fe contained in the cooling tower drainage 97 are settled and removed by adding an oxidization agent to the cooling tower drainage 97.

In the sulfide treatment method, SS and Fe contained in the cooling tower drainage 97 are settled and removed by adding sulfur-based flocculant or inorganic flocculant to the cooling tower drainage 97. Since the sulfide treatment method is the same as that of the sulfide treatment unit 103 of the first heavy metal/fluorine treatment unit 102A and sulfur-based flocculant and inorganic flocculant used in the sulfide treatment method are the same as sulfur-based flocculant and inorganic flocculant used in the sulfide method of the sulfide treatment unit 103, the repetitive description thereof will be omitted.

In the contact filtration method, SS and Fe contained in the cooling tower drainage 97 are absorbed to manganese zeolite so as to be removed by causing the cooling tower drainage 97 to pass through manganese zeolite. The manganese zeolite carries manganese in zeolite, and SS and Fe contained in the cooling tower drainage 97 are absorbed to the manganese zeolite so as to be removed by causing the cooling tower drainage 97 to pass through the manganese zeolite.

In the ion exchange method, SS and Fe contained in the cooling tower drainage 97 are absorbed to the manganese zeolite so as to be removed by causing the cooling tower drainage 97 to pass through an ion exchange resin. The ion exchange resin may be selected from existing examples, and the alternative example thereof is not particularly limited.

After at least SS and Fe contained in the cooling tower drainage 97 are removed by the fourth heavy metal/fluorine treatment unit 102D, the cooling tower drainage 97 is supplied to the third COD treatment unit 107C.

(Third COD Treatment Unit)

The third COD treatment unit 107C is used to remove at least benzene and CN contained in the cooling tower drainage 97. The third COD treatment unit 107C includes a BOD/COD treatment unit 115. The third CN treatment unit 113 treats at least benzene, BOD, and COD in the cooling tower drainage 97 treated in the fourth heavy metal/fluorine treatment unit 102D by using an activated coal treatment method or an activated sludge method.

In the activated coal treatment method, SS and Fe contained in the cooling tower drainage 97 are absorbed to the activated coal so as to be removed by causing the cooling tower drainage 97 to pass through the activated coal. Further, in the activated sludge method, benzene,

BOD, and COD contained in the cooling tower drainage 97 are removed by supplying aerobic microorganism (activated sludge) to the cooling tower drainage 97.

After benzene, BOD, and COD contained in the cooling tower drainage 97 are removed by the third COD treatment unit 107C, the cooling tower drainage 97 is discharged from the drainage treatment apparatus 101D.

Thus, since it is possible to highly efficiently remove heavy metal such as SS, Fe, benzene, BOD, and COD contained in the cooling tower drainage 97 in accordance with the properties and the states thereof by supplying the cooling tower drainage 97 to the drainage treatment apparatus 101D through the drainage treatment line L14, it is possible to decrease the amount of the drainage discharged from the integrated coal gasification combined cycle system 10.

Furthermore, in the embodiment, the cooling tower drainage 97 is supplied to the drainage treatment apparatus 101D through the drainage treatment line L14 so as to be treated in the treatment process D, but the invention is not limited thereto. For example, the cooling tower drainage 97 may be supplied to the drainage treatment apparatus 101C so as to be treated in the same process as the treatment process C.

(Treatment Process E)

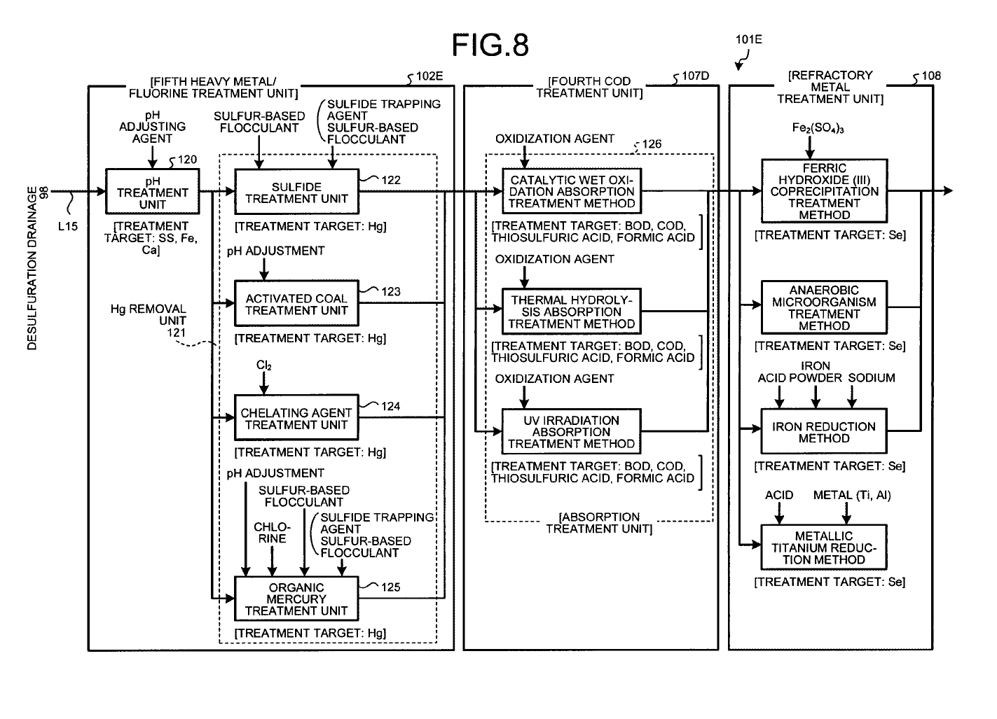

The desulfuration drainage 98 is supplied to the drainage treatment apparatus 101E through the drainage treatment line L15 (in FIGS. 1 and 2, the treatment process E). The drainage treatment apparatus 101E removes heavy metal such as SS, Fe, and Ca, Mn, Hg, Se, BOD, COD, thiosulfuric acid, and formic acid contained in the desulfuration drainage 98. An example of the components of the drainage treatment apparatus 101E is illustrated in FIG. 8. As illustrated in FIG. 8, the drainage treatment apparatus 101E includes a fifth heavy metal/fluorine treatment unit 102E, a fourth COD treatment unit 107D, and a refractory metal treatment unit 108.

(Fifth Heavy Metal/Fluorine Treatment Unit)

The fifth heavy metal/fluorine treatment unit 102E is used to remove at least SS, Fe, Ca, and Hg contained in the desulfuration drainage 98. The fifth heavy metal/fluorine treatment unit 102E includes a pH treatment unit 120 and an Hg removal unit 121. The pH treatment unit 120 is used to remove at least SS, Fe, and Ca contained in the desulfuration drainage 98 by adding a pH adjusting agent thereto. The Hg removal unit 121 is used to remove Hg in the desulfuration drainage 98 from which at least SS, Fe, and Ca are removed.

The pH treatment unit 120 adds the pH adjusting agent to the desulfuration drainage 98 and settles SS, Fe, and Ca contained in the desulfuration drainage 98 so as to be removed from the desulfuration drainage 98. As the pH adjusting agent, for example, lime hydrate, caustic soda, sodium carbonate, and the like may be exemplified. Accordingly, SS, Fe, and Ca contained in the desulfuration drainage 98 are removed.

After SS, Fe, and Ca contained in the desulfuration drainage 98 are removed by the pH treatment unit 120, the desulfuration drainage 98 is supplied to the Hg removal unit 121.

The Hg removal unit 121 includes a sulfide treatment unit 122, an activated coal treatment unit 123, a chelating agent treatment unit 124, and an organic mercury treatment unit 125, and the Hg removal unit 121 treats Hg in the desulfuration drainage 98 by using any one of the sulfide treatment unit 122, the activated coal treatment unit 123, the chelating agent treatment unit 124, and the organic mercury treatment unit 125 with respect to the desulfuration drainage 98.

The sulfide treatment unit 122 adds sulfur-based flocculant to the desulfuration drainage 98 and settles Hg contained in the desulfuration drainage 98 so as to be removed from the desulfuration drainage 98. The sulfide treatment unit 122 adds the sulfur-based flocculant to the desulfuration drainage 98 and settles Hg contained in the desulfuration drainage 98 so as to be removed. As the sulfur-based flocculant used in the sulfide treatment unit 122, for example, pyrrolidine, imine, and carbamic sulfur-based flocculants may be exemplified. As a sulfide trapping agent, for example, a sulfide trapping agent having a xanthate group and a dithiocarbamate group may be exemplified.

The activated coal treatment unit 123 is used to absorb Hg contained in the desulfuration drainage 98 to the activated coal so as to be removed by causing the desulfuration drainage 98 to flow through the activated coal. The activated coal treatment unit 123 is operated as in the activated coal treatment unit 112 of the first COD treatment unit 107A of the drainage treatment apparatus 101B. That is, the activated coal treatment unit 123 adjusts the pH of the desulfuration drainage 98 and causes the desulfuration drainage 98 to flow through the activated coal so that Hg contained in the desulfuration drainage 98 is absorbed to the activated coal so as to be removed.

The chelating agent treatment unit 124 is used to remove Hg contained in the desulfuration drainage 98 by adding chlorine to the desulfuration drainage 98.

The organic mercury treatment unit 125 adjusts the pH of the desulfuration drainage 98, adds chlorine and sulfur-based flocculant, and removes Hg in the desulfuration drainage 98 by using sulfide filler and sulfur-based flocculant.

After Hg contained in the desulfuration drainage 98 is removed by the Hg removal unit 121, the desulfuration drainage 98 is supplied to the fourth COD treatment unit 107D.

(Fourth COD Treatment Unit)

The fourth COD treatment unit 107D is used to remove at least BOD, COD, thiosulfuric acid, and formic acid contained in the desulfuration drainage 98. The fourth COD treatment unit 107D includes an absorption treatment unit 126. The absorption treatment unit 126 is used to remove at least BOD, COD, thiosulfuric acid, and formic acid in the desulfuration drainage 98 treated in the fifth heavy metal/fluorine treatment unit 102E. In the embodiment, the absorption treatment unit 126 uses any one of a catalytic wet oxidation absorption treatment method, a thermal hydrolysis absorption treatment method, and a UV irradiation absorption treatment method. Since such a treatment method is the same as the catalytic wet oxidation absorption treatment method, the thermal hydrolysis absorption treatment method, and the UV irradiation absorption treatment method used in the CN treatment unit 113 of the first COD treatment unit 107A, the repetitive description thereof will be omitted.

After BOD, COD, thiosulfuric acid, and formic acid contained in the desulfuration drainage 98 are removed by the fourth COD treatment unit 107D, the desulfuration drainage 98 is supplied to the refractory metal treatment unit 108.

(Refractory metal Treatment Unit)

The refractory metal treatment unit 108 is used to remove at least Se contained in the desulfuration drainage 98. The refractory metal treatment unit 108 treats the desulfuration drainage 98 treated in the fourth COD treatment unit 107D by using any one or more of a ferric hydroxide (III) coprecipitation treatment method, an anaerobic microorganism treatment method, an iron reduction method, and a metallic titanium reduction method. Since the treatment methods used in the refractory metal treatment unit 108 are the same as those of the refractory metal treatment unit 108 of the drainage treatment apparatus 101B, the repetitive description thereof will be omitted.

After Se contained in the desulfuration drainage 98 is removed by the refractory metal treatment unit 108, the cooling tower drainage 97 is discharged from the drainage treatment apparatus 101E.

Thus, since it is possible to highly efficiently remove Fe, Ca, Mn, Hg, Se, BOD, COD, thiosulfuric acid, formic acid, and the like contained in the desulfuration drainage 98 in accordance with the properties and the states thereof by supplying the desulfuration drainage 98 to the drainage treatment apparatus 101E through the drainage treatment line L15, it is possible to decrease the amount of the drainage discharged from the integrated coal gasification combined cycle system 10.

Furthermore, in the embodiment, the desulfuration drainage 98 is supplied to the drainage treatment apparatus 101E through the drainage treatment line L15 so as to be treated in the treatment process E, but the invention is not limited thereto. For example, the drainage treatment apparatus 101B may perform the same treatment process as the treatment process B. Further, the desulfuration drainage 98 may be supplied to the drainage treatment apparatus 101B so as to be treated in the same treatment process as the treatment process B.

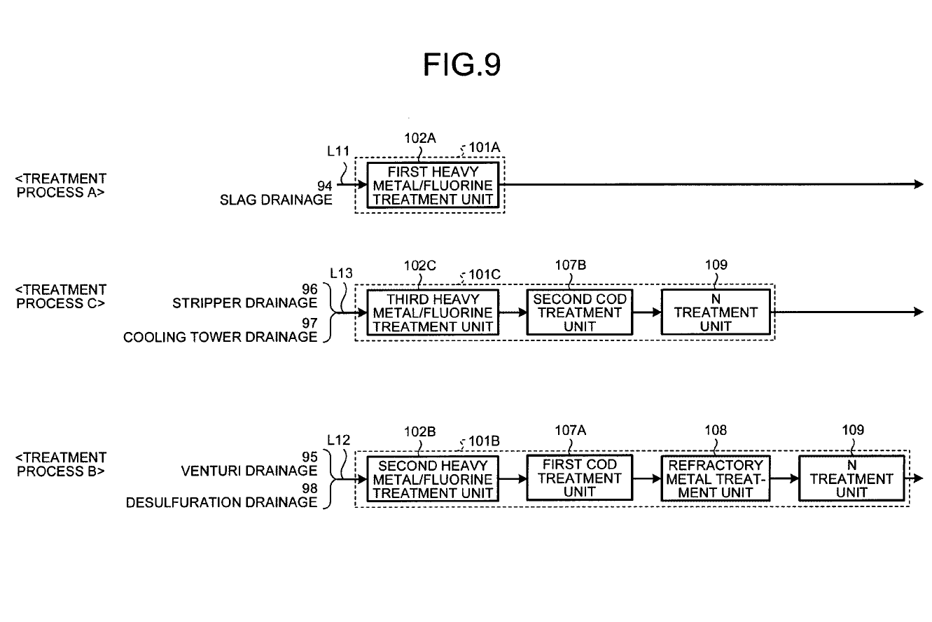

Further, in the embodiment, the cooling tower drainage 97 and the desulfuration drainage 98 are supplied to the drainage treatment apparatuses 101D and 101E through the drainage treatment lines L14 and L15 so as to be individually treated. However, the stripper drainage 96 and the cooling tower drainage 97 may be discharged as drainage after the same treatment process is performed thereon, and the venturi drainage 95 and the desulfuration drainage 98 may be discharged as drainage after the same treatment process is performed thereon. For that reason, as illustrated in FIG. 9, the stripper drainage 96 and the cooling tower drainage 97 may be simultaneously treated by the treatment process C of the drainage treatment apparatus 101C, and the venturi drainage 95 and the desulfuration drainage 98 may be simultaneously treated by the treatment process B of the drainage treatment apparatus 101B.

As described above, since the integrated coal gasification combined cycle system 10 that employs the drainage treatment system 16 according to the embodiment of the invention may appropriately treat the drainages in response to the properties and the states thereof by individually treating the drainages (in the embodiment, the slag drainage 94, the venturi drainage 95, and the stripper drainage 96) which are generated when the gasified gas 33 is produced by gasifying the pulverized coal 22 using the coal gasification furnace 12 and is purified by the gas purification device 14 and the drainages (in the embodiment, the cooling tower drainage 97 and the desulfuration drainage 98) which are generated when the gasified gas 33 is purified by the gas purification device 14 so as to treat the drainages discharged from the drainage treatment lines L11 to L15 in accordance with the properties and the states of the drainages, it is possible to decrease the amount of the drainage discharged from the integrated coal gasification combined cycle system 10 by highly efficiently treating the drainage. Further, since the recyclable drainage is returned as boiler water of the heat recovery steam generator 74 so as to be circulated as the cooling water in the heat recovery steam generator 74, it is possible to decrease the amount of the drainage to be discharged. Accordingly, it is possible to remarkably decrease the amount of the drainage (for example, by 10%), and hence to drastically decrease the industrial water usage amount (for example, by 10%).

Thus, according to the integrated coal gasification combined cycle system 10 that employs the drainage treatment system 16 according to the embodiment of the invention, it is possible to highly efficiently and stably operate the integrated coal gasification combined cycle system 10 while decreasing the amount of the drainage.

Furthermore, in the embodiment, coal is used as the raw material, but the coal may be high-grade coal or low-grade coal. Further, the invention is not limited to the coal, biomass which is used as an organic resource generated from a regenerable living object may be used. For example, timber, waste wood, drift wood, grass, waste, mud, a tire, and a recycled fuel (pellet or chip) using these examples as raw materials may be used.

Further, in the embodiment, the steam turbine 72 includes two channels, that is, a high-pressure channel and a low-pressure channel, but the embodiment is not limited thereto. For example, the steam turbine may have three channels, that is, a low-pressure channel, a middle-pressure channel, and a high-pressure channel.

Further, in the embodiment, a case has been described in which the combined power generation facility is applied to the uniaxial gas turbine combined cycle generation system, but the embodiment is not limited thereto. For example, the invention may be applied to a multi-axial gas turbine combined cycle generation system in which a gas turbine and a steam turbine are connected by separate shafts other than the uniaxial gas turbine combined cycle generation system.

Further, in the embodiment, a case has been described in which the pure gas 45 discharged from the gas purification device 14 is used as the gas turbine gas. However, since the CO shift reaction device 54 converts a large amount of CO contained in the gasified gas 33 into CO₂, the pure gas may be used to, for example, generate power in a fuel cell, produce hydrogen, and synthesize chemical products such as dimethyl ether (DAME), methanol, and ammonia while being used as a raw material gas other than the gas turbine gas.

As described above, a case has been described in which the CO shift reaction device 54 according to the embodiment treats drainage generated when the gasified gas 33 generated by gasifying a fuel such as the coal 21 using the coal gasification furnace 12 is converted into the pure gas 45, the invention is not limited thereto. For example, the invention may be also applied to the case where drainage generated when a gas containing CO in a fuel cell is converted into the pure gas 45.

### REFERENCE SIGNS LIST

10 Integrated Coal Gasification Combined Cycle System
11 Coal Feeder
12 Coal Gasification Furnace
12a Reacting Furnace
13 Char Recovery Unit
14 Gas Purification Device
15 Combined Power Generation Facility
16 Drainage Treatment System
21 Coal Pulverizer
21 Coal
22 Pulverized Coal
23 Pulverized Coal Bag Filter
24 Pulverized Coal Supply Hopper
25 Air Separation Device
26 First Nitrogen Supply Line
27 Coal Supply Line
28 Second Nitrogen Supply Line
29 Char Return Line
30 Oxygen Supply Line
31 Compressed Air Supply Line
33 Coal Gasified Gas (Gasified Gas)
35 Slag Discharge System
36 Gasified Gas Supply Line
37 Heat Exchanger
41 Dust Recovery Unit
42 Supply Hopper
43 Gas Discharge Line
45 Fuel Gas (Pure Gas)
51 Gas Cooling Tower
52 Water Cleaning Tower
53 COS Conversion Device
54 CO Shift Reaction Device
55 H₂S/CO₂ Recovery Unit
56 Stripper
58 Cooling Water
59 Cleaning Liquid
60 Steam
61 Adiabatic Reactor (Reactor)
62 CO Shift Catalyst Layer
63 Reformed Gas
64 Flash Drum
65 Offgas
66 Washing Liquid
67 Offgas Combustion Furnace
71 Gas Turbine
72 Steam Turbine
73 Generator
74 Heat Recovery Steam Generator (HRSG)
75 Compressor
76 Combustor
77, 83 Turbine
78 Rotation Shaft
79 Compressed Air Supply Line
80 Fuel Gas Supply Line
81 Combustion Gas Supply Line
82 Booster
84 Flue Gas Line
85 Flue Gas
86 Steam
87 Air
88 Combustion Gas
89 Steam Supply Line
90 Steam Recovery Line
91 Condenser
92 Stack
94 Slag Drainage
95 Venturi Drainage
96 Stripper Drainage
97 Cooling Tower Drainage
98 Desulfuration Drainage
101A to 101E Drainage Treatment Apparatus (Drainage Treatment Unit)
102A to 102E First Heavy Metal/Fluorine Treatment Unit To Fifth Heavy Metal/Fluorine Treatment Unit
103 Sulfide Treatment Unit
104 AA Treatment Unit
105 SS Treatment Unit
107a To 107d First Cod Treatment Unit To Fourth Cod Treatment Unit
108 Refractory Metal Treatment Unit
109 N Treatment Unit
111 CaF Treatment Unit
112 Activated Coal Treatment Unit
113 CN Treatment Unit
114 SS/Fe Treatment Unit
115 BOD/COD Treatment Unit
120 pH Treatment Unit
121 Hg Removal Unit
122 Sulfide Treatment Unit
123 Activated Coal Treatment Unit
124 Chelating Agent Treatment Unit
125 Organic Mercury Treatment Unit
126 Absorption Treatment Unit
L11 to L15 Drainage Treatment Line

1. A drainage treatment system that treats drainage generated when a gasified gas is produced by gasifying coal as a fuel in a gasification furnace and is purified by a purification device, the drainage treatment system comprising:
a plurality of drainage treatment lines that respectively treat a plurality of drainages generated when the gasified gas is produced and the produced gasified gas is cleaned; and
a drainage treatment unit that is provided in each drainage treatment line and treats a treatment target material contained in the drainage discharged from each drainage treatment line,
wherein the drainages generated when the gasified gas is produced and the produced gasified gas is cleaned correspond to any one of drainage including at least one of a group of alkali metal and alkali earth metal, drainage containing a large amount of ammonia, and final treatment drainage,
wherein the drainage treatment unit includes a first heavy metal/fluorine treatment unit that removes at least SS, Pb, F, and Hg contained in drainage including at least one of the group of alkali metal and alkali earth metal, and
wherein the first heavy metal/fluorine treatment unit includes a sulfide treatment unit that removes at least Pb and Mn contained in drainage including at least one of the group of alkali metal and alkali earth metal from the drainage including at least one of the group of alkali metal and alkali earth metal, and
wherein each drainage of the drainage treatment line is individually treated in response to the treatment target material contained in the drainage without mixing the drainages of the drainage treatment lines.

2. The drainage treatment system according to claim 1,
wherein the first heavy metal/fluorine treatment unit includes any one of or both an As treatment unit that removes at least As contained in drainage including at least one of the group of alkali metal and alkali earth metal by using a ferrite method or an iron powder method, and an SS treatment unit that removes SS contained in drainage including at least one of the group of alkali metal and alkali earth metal by using a filtration treatment method or a membrane treatment method.

3. A drainage treatment system that treats drainage generated when a gasified gas is produced by gasifying coal as a fuel in a gasification furnace and is purified by a purification device, the drainage treatment system comprising:
a plurality of drainage treatment lines that respectively treat a plurality of drainages generated when the gasified gas is produced and the produced gasified gas is cleaned; and
a drainage treatment unit that is provided in each drainage treatment line and treats a treatment target material contained in the drainage discharged from each drainage treatment line,
wherein the drainage treatment unit includes
a second heavy metal/fluorine treatment unit that removes at least SS, Cr, F, and As in the drainage containing a large amount of ammonia,
a first COD treatment unit that removes at least benzene and COD in the drainage containing a large amount of ammonia,
a refractory metal treatment unit that removes at least Se in the drainage containing a large amount of ammonia, and
an N treatment unit that removes at least NH₃ in the drainage containing a large amount of ammonia,
wherein the second heavy metal/fluorine treatment unit includes a calcium fluoride treatment unit that removes at least SS, Cr, and F in the drainage containing a large amount of ammonia by using Ca(OH)₂ and an flocculant and an As treatment unit that removes at least As in the drainage containing a large amount of ammonia by using a ferrite method or an iron powder method,
wherein the first COD treatment unit includes an activated coal treatment unit that removes benzene in the drainage containing a large amount of ammonia and treated in the second heavy metal/fluorine treatment unit and a CN treatment unit that removes at least BOD, COD, and CN in the drainage containing a large amount of ammonia by using any one of an oxidization agent, NaOH, and Fe from the drainage containing a large amount of ammonia and subjected to the activated coal treatment,
wherein the refractory metal treatment unit treats the drainage containing a large amount of ammonia and treated in the first COD treatment unit by using any one or more of a ferric hydroxide (III) coprecipitation treatment method, an anaerobic microorganism treatment method, an iron reduction method, and a metallic titanium reduction method,
wherein the N treatment unit removes NH₃ in the drainage containing ammonia and treated in the refractory metal treatment unit,
wherein the drainages generated when the gasified gas is produced and the produced gasified gas is cleaned correspond to any one of drainage including at least one of a group of alkali metal and alkali earth metal, drainage containing a large amount of ammonia, and final treatment drainage, and
wherein each drainage of the drainage treatment line is individually treated in response to the treatment target material contained in the drainage without mixing the drainages of the drainage treatment lines.

4. A drainage treatment system that treats drainage generated when a gasified gas is produced by gasifying coal as a fuel in a gasification furnace and is purified by a purification device, the drainage treatment system comprising:
a plurality of drainage treatment lines that respectively treat a plurality of drainages generated when the gasified gas is produced and the produced gasified gas is cleaned; and
a drainage treatment unit that is provided in each drainage treatment line and treats a treatment target material contained in the drainage discharged from each drainage treatment line,
wherein the drainage treatment unit includes
a third heavy metal/fluorine treatment unit that removes at least F in the final treatment drainage,
a second COD treatment unit that removes at least benzene and CN in the final treatment drainage, and
an N treatment unit that removes at least NH₃ in the final treatment drainage,
wherein the third heavy metal/fluorine treatment unit includes a calcium fluoride treatment unit that removes at least SS, Cr, and F in the final treatment drainage by using Ca(OH)₂ and a flocculant,
wherein the second COD treatment unit includes a second CN treatment unit that removes at least benzene and CN in the final treatment drainage treated in the third heavy metal/fluorine treatment unit, and
wherein the N treatment unit removes NH₃ in the final treatment drainage treated in the second COD treatment unit.
wherein the drainages generated when the gasified gas is produced and the produced gasified gas is cleaned correspond to any one of drainage including at least one of a group of alkali metal and alkali earth metal, drainage containing a large amount of ammonia, and final treatment drainage, and
wherein each drainage of the drainage treatment line is individually treated in response to the treatment target material contained in the drainage without mixing the drainages of the drainage treatment lines.

5. The drainage treatment system according to claim 1,
wherein the purification device includes a gas cooling tower that cools the gasified gas, a water cleaning tower that removes at least ammonia in the gasified gas, a H₂S/CO₂ recovery unit that removes any one of or both CO₂ and H₂S in the gasified gas, and a stripper that absorbs ammonia contained in the drainage discharged from the gas cooling tower by using at least an absorbent, and
wherein the drainages generated when the gasified gas is produced and the generated gasified gas is cleaned correspond to drainage discharged from any one of the gasification furnace, the water cleaning tower, and the stripper.

6. The drainage treatment system according to claim 1,
wherein the drainage treatment unit treats drainage generated when the gasified gas is purified by the purification device.

7. The drainage treatment system according to claim 6,
wherein drainage generated when the gasified gas is purified by the purification device is any one of cooling tower drainage discharged from the gas cooling tower and desulfuration drainage discharged from the H₂S/CO₇ recovery unit.

8. The drainage treatment system according to claim 7,
wherein the drainage treatment unit includes
a fourth heavy metal/fluorine treatment unit that removes at least SS and Fe in the cooling tower drainage, and
a third COD treatment unit that removes at least benzene and CN in the cooling tower drainage,
wherein the fourth heavy metal/fluorine treatment unit includes an SS/Fe treatment unit that removes at least SS and Fe in the cooling tower drainage by using any one of Na(OH), an oxidization agent, sulfur-based flocculant, manganese zeolite, and ion exchange resin, and
wherein the third COD treatment unit includes a benzene/BOD/COD treatment unit that treats at least benzene, BOD, and COD in the cooling tower drainage treated in the fourth heavy metal/fluorine treatment unit by using an activated coal treatment method or an activated sludge method.

9. The drainage treatment system according to claim 7,
wherein the drainage treatment unit includes
a fifth heavy metal/fluorine treatment unit that removes at least SS, Fe, Ca, and Hg in the desulfuration drainage,
a fourth COD treatment unit that removes at least benzene and CN in the desulfuration drainage, and
a refractory metal treatment unit that removes at least Se in the desulfuration drainage,
wherein the fifth heavy metal/fluorine treatment unit includes
a pH treatment unit that removes at least SS, Fe, and Ca in the desulfuration drainage by adding a pH adjusting agent thereto, and
a Hg removal unit that removes Hg in the desulfuration drainage from which at least SS, Fe, and Ca are removed,
wherein the fourth COD treatment unit includes an absorption treatment unit that removes at least BOD, COD, thiosulfuric acid, and formic acid in the cooling tower drainage treated in the fifth heavy metal/fluorine treatment unit, and
wherein the refractory metal treatment unit treats the desulfuration drainage treated in the fourth COD treatment unit by using any one or more of a ferric hydroxide (III) coprecipitation treatment method, an anaerobic microorganism treatment method, an iron reduction method, and a metallic titanium reduction method.

10. A combined power generation facility comprising:
a gasification furnace that produces a gasified gas by gasifying coal;
a purification device that produces a pure gas by purifying the gasified gas;
the drainage treatment system according to claim 1;
a gas turbine;
a steam turbine that is driven by steam generated by a heat recovery steam generator; and
a condenser that condenses the steam from the steam turbine.

11. (canceled)

12. (canceled)
